(19) United States
(12) Patent Application Publication
(10) Pub. No.: US 2009/0207518 A1
(43) Pub. Date: Aug. 20, 2009

(54) Microdisk array apparatus using semiconductor automated equipment

(75) Inventors: Wen-Sen Tsai, Hsinchu County (TW); Chun-Hung Shen, Hsinchu County (TW)

Correspondence Address: BACON & THOMAS, PLLC, 625 SLATERS LANE, FOURTH FLOOR, ALEXANDRIA, VA, 22314-1176, US

(73) Assignee: ACCUSYS. INC., JHUBEI CITY (TW)

(21) Appl. No.: 12/232,849

(22) Filed: Sep. 25, 2008

(30) Foreign Application Priority Data
Feb. 20, 2008 (TW) 097202964

(51) Int. Cl. G11B 5/02

(52) U.S. Cl. 360/55; G9B/5.026

(57) ABSTRACT

The present invention discloses a microdisk array apparatus using semiconductor automated equipment, and the apparatus is installed into a space of a 3.5-inch IDE hard disk of the semiconductor equipment to substitute the hard disk directly. The apparatus includes a frame, and the frame has a connecting interface, a disk array controller and storage devices. During use, the semiconductor equipment stores, reads, updates and copies data with the storage devices through the connecting interface and the disk array controller. The storage device can be a 2.5-inch IDE hard disk or solid state disk. Since the IDE hard disk becomes a mainstream storage device of the semiconductor equipment, and the solid state disk has the quiet, fast, compact and long-life features, the apparatus is compatible to the storage devices of these two specifications, so as to provide better data storage and backup.

### BACKGROUND OF THE INVENTION

1. Field of the Invention

The present invention relates to a microdisk array apparatus using a semiconductor automated equipment, and more particularly to a microdisk array apparatus capable of replacing a 3.5-inch IDE hard disk installed in the semiconductor equipment to provide the functions of reading, updating and copying data required for the operations of the semiconductor equipment, and improving the storage and backup of parameters for the operations of the semiconductor equipment.

2. Description of the Related Art

Hard disk is one of the popular information storage devices, and the advantage of its large capacity makes the hard disk an indispensable device among various different storage devices. In recent years, the capacity, accessing speed and reliability of a hard disk have been improved greatly, but the security of the hard disk still cannot meet user requirements yet, and the security for protecting important data becomes a bottleneck to the development of semiconductor equipments. For example, a control system for conventional semiconductor equipments is connected to a 3.5-inch IDE hard disk for storing important data and serving as a transmitting component. If the hard disk is damaged, then the data will be lost. Furthermore, it is necessary to turn off the system to repair and recover data, and thus incurs high production costs and manpower.

To prevent a data loss of the hard disk during the operation of the semiconductor equipment, or prevent affecting the operation of the semiconductor equipment, manufacturers generally build a disk array apparatus in the semiconductor equipment, and the disk array apparatus includes at least two hard disks, so that the operating data required for setup can be read from any one of the hard disks, while a new data produced by the semiconductor equipment can be stored into the two hard disks. If one of the hard disks is damaged or removed, another hard disk can still provide a normal operation of the semiconductor equipment. In addition, the design of the disk array apparatus allows users to swap a damaged hard disk with a good hard disk easily, when the automated equipment fails. After the failed hard disk is replaced by a new hard disk, new data will be copied automatically to assure the data synchronization of the two hard disks, so as to effectively provide better data storage and backup.

Since a general hard disk is a mechanical device, hard disks may be adversely affected by mechanical damages and vibrations, and the speed of accessing and copying data is affected by the operation of a mechanical motor and the movement of a pickup head. The solid state disk (SSD) adopts flash memories for data storage and backup, and thus SSD does not have the aforementioned drawbacks of the hard disk, and the flash memory has the advantages of quiet and fast data storage and transmission as well as a light, thin, short and compact design. Obviously, SSD tends to replace hard disks in the future. It is a major subject of the present invention to find a way of integrating a hard disk and a solid state disk into a same disk array apparatus, such that the apparatus can substitute the storage devices in the semiconductor equipment easily and meet the requirements for better data storage and backup.

### SUMMARY OF THE INVENTION

In view of the foregoing shortcomings of the prior art, the inventor of the present invention based on years of experience in the related industry to conduct extensive researches and experiments, and finally developed a microdisk array apparatus using a semiconductor automated equipment in accordance with the present invention.

Therefore, it is a primary objective of the present invention to provide a microdisk array apparatus using a semiconductor automated equipment, and the apparatus can be contained precisely in a space of a 3.5-inch IDE hard disk installed in the semiconductor equipment for substituting a hard disk of the semiconductor equipment to build a microdisk array apparatus and achieve convenient and practical applications.

A secondary objective of the present invention is to provide a microdisk array apparatus, and the storage device of the apparatus is a hard disk which is still the mainstream storage device at present and makes use of the advantages of its large storage capacity, low price and easy access to lower the user's cost.

A third objective of the present invention is to provide a microdisk array apparatus, and the storage device of the apparatus is a solid state disk having the quiet, fast, light, thin, short, compact and easy-to-carry features.

A fourth objective of the present invention is to provide a microdisk array apparatus, and the apparatus is compatible with two specifications respectively: a hard disk and a solid state disk, for facilitating users to store and copy data.

A fifth objective of the present invention is to provide a microdisk array apparatus, and the apparatus includes a display device for showing the operation of the storage devices.

A sixth objective of the present invention is to provide a microdisk array apparatus, and the apparatus provides a locking structure for a convenient replacement of a storage device when the storage device is full or the storage device is failed.

To achieve the foregoing objectives, the present invention provides a microdisk array apparatus using a semiconductor automated equipment, and the apparatus includes a main body, and the main body includes at least one base and a retaining base for containing a plurality of storage devices, and the base is in the shape of a frame and installed precisely in a space of a 3.5-inch IDE hard disk of the semiconductor equipment, and the base includes a connecting interface connected to the semiconductor equipment and a disk control system for controlling the operation of the disk array apparatus; wherein the plurality of retaining bases are in the shape of a frame and contained precisely in the base, and the interior of the retaining bases can contain a traditional 2.5-inch hard disk or solid state disk. Further, the front of the retaining base includes a handle and a latching element, such that a hand tool can be used for facilitating a release of the latch of the retaining base from the base, and the handle can be used for sliding the retaining base out of the base.

To make it easier for our examiner to understand the present invention, we use preferred embodiments accompanied with related drawings for the detailed description of the present invention as follows.

### BRIEF DESCRIPTION OF THE DRAWINGS

FIG. 1 is a schematic view of a logic used in semiconductor automated equipment in accordance with the present invention;

FIG. 2 is an exploded view of the present invention;

FIG. 3 is a perspective view of the present invention;

FIG. 4 is a schematic view of operating a locking latch of the present invention;

FIG. 4a is another schematic view of a locking latch of the present invention; and

FIG. 5 is a schematic view of the present invention being applied in semiconductor automated equipment.

### DETAILED DESCRIPTION OF THE PREFERRED EMBODIMENTS

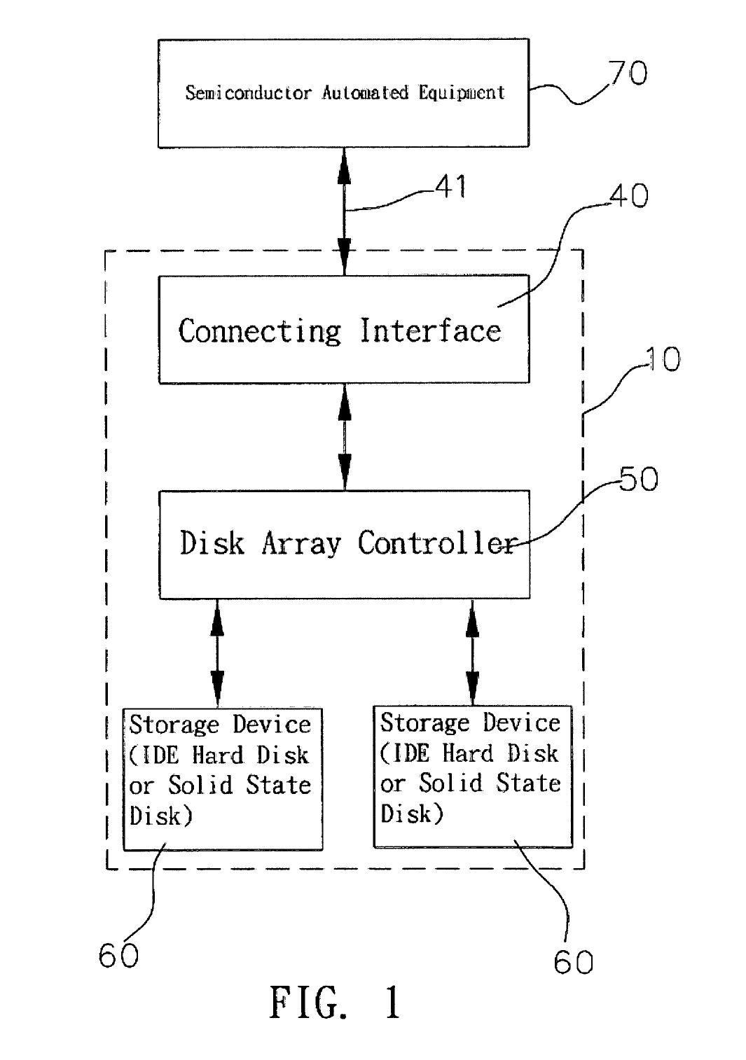

Referring to FIG. 1 for a microdisk array apparatus using a semiconductor automated equipment in accordance with the present invention, the apparatus is installed in a space of a 3.5-inch IDE hard disk of a semiconductor automated equipment 70, and the apparatus is installed on a main body 10, and the main body 10 comprises a connecting interface 40, a disk array controller 50 and a plurality of storage devices 60.

The connecting interface 40 is electrically coupled to the semiconductor automated equipment 70 through a transmission line 41, and the connecting interface 40 can support different transmission protocols such as SATA, PATA, SCSI, USB and IEEE 1394.

The disk array controller 50 comes with an end electrically coupled to the connecting interface 40, and the disk array controller 50 supports functions defined for a traditional disk array (RAID) apparatus. For example, a hot swap supports the functions of automatically recovering data and repairing a bad track without turning off the system. If the connecting interface 40 is a PATA interface, the interface supports specification of a master disk or a slave disk with a PATA interface. If the connecting interface 40 is a SCSI interface, the interface supports setting and adjusting an ID (or a position of a disk) of a SCSI interface. In the meantime, the disk array controller 50 can support different specifications such as a traditional hard disk or solid state disk.

The plurality of storage devices 60 are general hard disks or solid state disks. In this embodiment, two storage devices 60 are adopted. The storage devices 60 are electrically coupled to the disk array controller 50 and used for providing data to the disk array controller 50 for storing, reading, updating and copying data required for the operation of the semiconductor automated equipment 70.

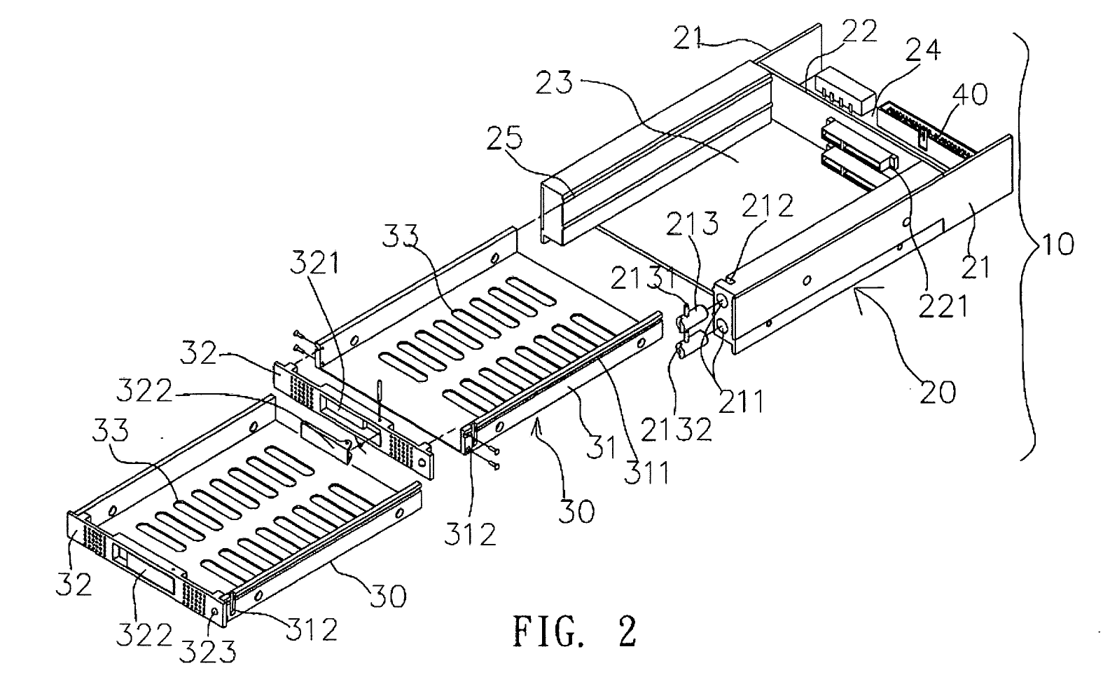

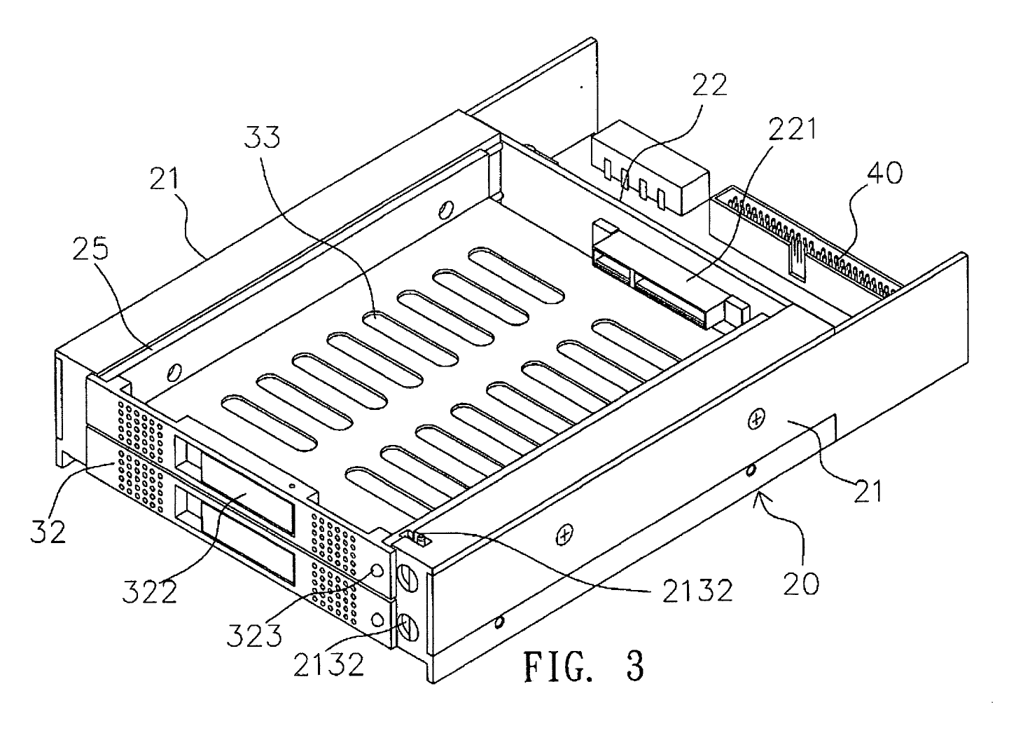

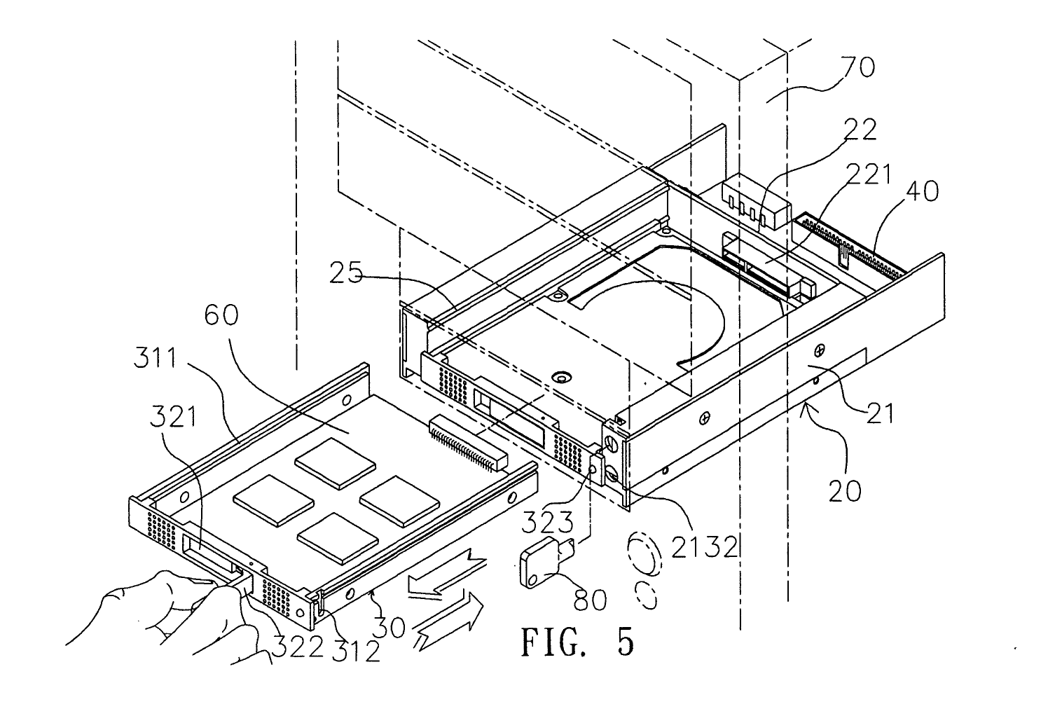

In FIGS. 2 and 3, the main body 10 further comprises a base 20 and a plurality of retaining bases 30. In this embodiment, the base 20 is in the shape of a frame with the dimensions of 145˜155 mm (length), 95˜105 mm (width) and 20˜30 mm (height) and contained precisely in a space of a 3.5-inch IDE hard disk of the semiconductor automated equipment 70 as shown in FIG. 5, and the base 20 has two parallel and corresponding side panels 21, and a rear panel 22 installed between the side panels 21 and perpendicular to the side panels 21, and the rear panel 22 has a plurality of ports 221 disposed thereon. Further, the rear panel 22 separates the interior of the base 20 into front and rear containing spaces 23, 24, and the front containing space 23 contains a plurality of parallel slide rods 25 (which are protruding pillars in this embodiment) disposed on the internal sides and corresponding to the side panels 21, and the rear containing space 24 includes a connecting interface 40.

Further, an opening 211 and a notch 212 are interconnected with each other and disposed on the side panel 21 and at an end away from the rear panel 22. In this embodiment, the opening 211 is a hole penetrating into an open end of the side panel 21, and the notch 212 is a cut groove perpendicular to the opening 211. The opening 211 is provided for precisely containing a latching element 213, and the latching element 213 is in a shape of a pillar, and the latching element 213 can be rotated in the opening 211, and a pressing pillar 2131 is protruded perpendicularly from the latching element 213. The front edge of the latching element 213 has a concave groove 2132 in a specific shape, and a hand tool 80 (not shown in the figure) in the same shape of the concave groove 2132 is pressed and rotated to turn the pressing pillar 2131 together with the latching element 213 and received or protruded at the notch 212.

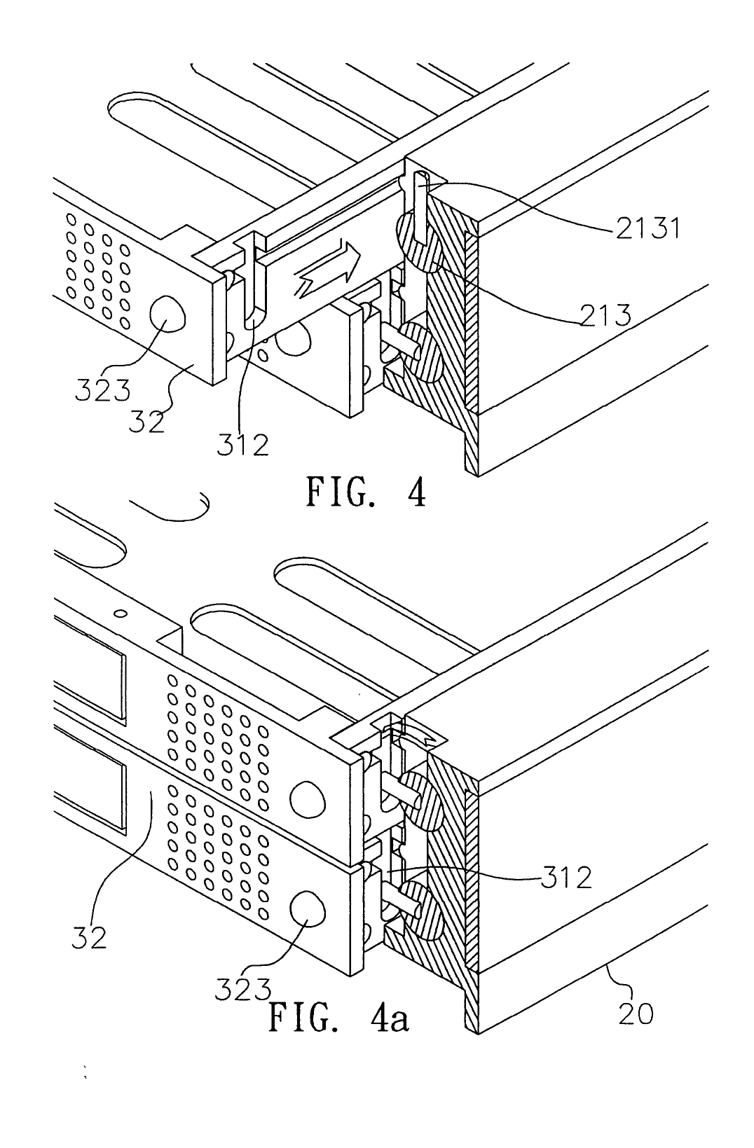

The plurality of retaining bases 30 (which are two n-shaped frames in this embodiment) can be contained precisely in the base 20, and the retaining base 30 has two corresponding side panels 31, and the side panels 31 have a slide groove 311 (which is a concave groove in this embodiment) disposed on an external side of each side panel 31 and corresponding to the slide rod 25 on the base 20, and the slide groove 311 can slide back and front on the slide rod 25. Further, a front panel 32 is perpendicularly disposed at the front end proximate to the corresponding side panels 31, and the front panel 32 has a subsided space 321 for installing a handle 322 (which is a plate in this embodiment), and an end of the handle 322 is pivotally coupled to a side in the subsided space 321, such that when a side proximate to a pivotal connecting end of the handle 322 is pressed, the handle 322 can be popped out from an end away from the pivotal connecting end. Further, a notch 312 is disposed on the side panel 31 along the longitudinal direction and at a position proximate to the front panel 32, for sliding the pressing pillar 2131 on the latching element 213 (as shown in FIGS. 4 and 4a). Further, a display device 323 is installed at an appropriate position on the front panel 32 for indicating the operating condition of the storage devices 60.

The side panels 31 and the front panel 32 of the retaining base 30 are enclosed to define a disk installing space 33 of a storage device 60 for precisely installing the storage device 60 (as shown in FIG. 5), and the storage devices 60 in the retaining base 30 are 2.5-inch IDE hard disk or solid state disk.

During a use as shown in FIG. 5, the storage devices 60 are fixed onto the retaining base 30, and the slide grooves 311 of the retaining bases 30 are slid into the slide rods 25 on the base 20 respectively, so that the storage devices 60 are electrically coupled to the ports 221 on the rear panel 22 of the base 20, and then the front end of a hand tool 80 is inserted into a concave groove 2132 at the front edge of the latching element 213, and the hand tool 80 is rotated to drive the pressing pillar 2131 and latched into the notch 312 (as shown in FIGS. 4 and 4a), so as to secure the retaining base 30 into the base 20.

On the other hand, if it is necessary to replace the storage device 60, the front end of the hand tool 80 is inserted into a concave groove 2132 at the front end of the latching element 213. After the hand tool 80 is turned in an opposite direction to drive the pressing pillar 2131 to separate the notch 312, a side of the pivotal connecting end proximate to the handle 322 is pressed, such that the handle 322 is popped outward from an end away from the pivotal connecting end, and a force is applied to the handle 322 to draw the handle 322 outward in order to facilitate the swap of the storage devices 60.

In addition, the disk array apparatus includes a display device 323 (which is an LED in this embodiment for indicating the operating conditions of the display devices 323, such as the indication of power of each storage device 60, the indication of reading data and the indication of a damaged disk, etc.

In summation of the description above, the present invention integrates the present existing disk array technology with a solid state disk which will become a mainstream storage device in the future to facilitate the replacement of disks and combining with other new technological products for different applications.

While the invention has been described by means of specific embodiments, numerous modifications and variations could be made thereto by those skilled in the art without departing from the scope and spirit of the invention set forth in the claims.

What is claimed is:

1. A microdisk array apparatus using a semiconductor automated equipment, and the apparatus comprising:
a main body, further comprising:
a base, being in the shape of a frame, and contained in a space of a 3.5-inch hard disk in the semiconductor equipment, and the base having a length of 145 mm to 155 mm, a width of 95 mm to 105 mm, and a height of 20 mm to 30 mm;
a plurality of retaining bases, being in the shape of a frame, and contained in the base;
a connecting interface, installed in the base, and having an end electrically coupled to the semiconductor equipment, for transmitting data through the connecting interface;
a disk array controller, installed in the base, and electrically coupled to the connecting interface, for storing, reading, updating and coping a control data; and
a plurality of storage devices, installed in the retaining base, and electrically coupled to the disk array controller;
thereby, the data is stored into the storage devices by an array method and the control of the disk array controller.

2. The microdisk array apparatus using a semiconductor automated equipment of claim 1, wherein the storage device is a 2.5-inch PATA hard disk or a 2.5-inch SATA hard disk.

3. The microdisk array apparatus using a semiconductor automated equipment of claim 1, wherein the storage device is a PATA solid state disk (SSD) or a SATA solid state disk (SSD).

4. The microdisk array apparatus using a semiconductor automated equipment of claim 1, wherein the connecting interface is coupled to the semiconductor automated equipment by a transmission line.

5. The microdisk array apparatus using a semiconductor automated equipment of claim 1, wherein the connecting interface supports a communication protocol selected from the collection of SATA, PATA, SCSI, USB and IEEE 1394.

6. The microdisk array apparatus using a semiconductor automated equipment of claim 1, wherein the disk array controller supports a standard storage function of an IDE hard disk and a solid state disk.

7. The microdisk array apparatus using a semiconductor automated equipment of claim 6, wherein the disk array controller supports a protocol selected from the collection of a flash IDE disk, a flash SATA disk, a PATA disk and a SATA disk.

8. The microdisk array apparatus using a semiconductor automated equipment of claim 1, wherein the apparatus supports a hot swap function of a flash memory of the storage device.

9. The microdisk array apparatus using a semiconductor automated equipment of claim 1, wherein the apparatus includes a display device for indicating the operating condition of the storage devices.

10. The microdisk array apparatus using a semiconductor automated equipment of claim 1, wherein the apparatus supports an automatic data recovery of the storage devices online.

11. The microdisk array apparatus using a semiconductor automated equipment of claim 1, wherein the apparatus supports a bad track repair of the storage devices online.

12. The microdisk array apparatus using a semiconductor automated equipment of claim 1, wherein the apparatus is installed selectively at a position of a master hard disk or a slave hard disk of a PATA interface of the semiconductor equipment.

13. The microdisk array apparatus using a semiconductor automated equipment of claim 1, wherein the apparatus is set and adjusted selectively at an ID (which is a position of the disk device) of a SCSI interface of the semiconductor equipment.

14. The microdisk array apparatus using a semiconductor automated equipment of claim 1, wherein the base and the retaining base include a slide rod and a corresponding slide groove respectively to slide the retaining base back and forth on the base.

15. The microdisk array apparatus using a semiconductor automated equipment of claim 1, wherein the base further comprises:
two parallel and corresponding side panels, installed on the base;
a rear panel, installed between the two corresponding side panels, and vertically between the side panels;
an opening, disposed at a distal edge of the side panel, and being in the shape of a hole penetrating inward; and
a notch, disposed at an end of the side panel and adjacent to the opening, and vertically interconnected with the opening.

16. The microdisk array apparatus using a semiconductor automated equipment of claim 1, wherein the retaining base includes a front panel disposed at the front side of the retaining base, and a handle provided for users to apply a force at the handle to detach the retaining base from the base.

17. The microdisk array apparatus using a semiconductor automated equipment of claim 16, wherein the front panel further includes a subsided space for precisely containing the handle.

18. The microdisk array apparatus using a semiconductor automated equipment of claim 17, wherein the handle comes with an end pivotally coupled to a side in the subsided space, for pressing a side of the pivotal connecting end of the handle to pop the handle out from an end which is away from the pivotal connecting end, and the handle is provided for users to apply forces.

19. The microdisk array apparatus using a semiconductor automated equipment of claim 15, wherein the opening is provided for precisely containing a latching element, and the latching element includes a protruded pressing pillar, such that the latching element can be rotated in the opening, and the pressing pillar can be rotated with the latching element accordingly, and accommodated into or protruded from the notch.
